(19) United States
(12) Patent Application Publication
(10) Pub. No.: US 2007/0198585 A1
(43) Pub. Date: Aug. 23, 2007

(54) Method for encouraging home ownership

(76) Inventor: Steven S. Adamec, Charlotte, NC (US)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/354,771

(22) Filed: Feb. 15, 2006

(51) Int. Cl. G06F 17/00

(52) U.S. Cl. 707/104.1

(57) ABSTRACT

A method of enabling a buyer to transition from renting a home to owning a home is provided.

### BACKGROUND OF THE INVENTION

The invention relates to the field of real estate. More specifically, the invention relates to the field of increased home ownership.

Owning a home is often considered the ultimate American dream. Home ownership provides many benefits, including, but not limited to, pride, tax deductions, and improved credit scores. Additionally, home ownership enables improved planning for the future, such as retirement. Moreover, a common economic indicator of the well-being of a location is the percentage of residents who own their own home.

Many potential home owners, however, find it difficult to take the steps necessary to purchase a home. This is often due to problems such as lack of savings and poor credit scores. As a result, these people are left with the option of renting a home.

Rent is often similar in amount to a mortgage payment, if not more than a typical mortgage payment, on a given property. Renters may be unable to save the money necessary to purchase a home while renting due to high rental costs and may find it difficult, therefore, to transition from renting a home to owning a home.

Additionally, individuals who relocate to an area, such as a new city, often want time to learn the area before committing to the purchase of a home. These individuals often choose to rent for a short period of time (e.g., six months or a year) while they learn more about their new location, such as information relating to commute times and conditions, school districts, and availability of and distance to various city amenities such as parks, restaurants, and entertainment venues.

Renters, whether individuals facing difficulties in purchasing a new home such as those listed above, individuals renting due to relocation and prior to purchasing a home, or individuals reluctant to embark on such a major purchase, often desire a centralized information source to find a rental property that meets their needs.

Several databases of available rental properties exist on the World Wide Web (i.e., the Internet). These databases typically charge fees to property management groups and/or property owners to list their available rental properties on the database. Potential renters may then access the database, often at no charge, to find desirable rental properties. These databases, however, often do not have a mechanism to enable or encourage renters to transition from renting a home to owning a home.

Government sponsored programs that encourage home ownership often allow individuals to purchase homes with small down payments, obviating the need for extensive savings. These programs do not, however, adequately address the issues raised when individuals have poor credit histories. These individuals often, therefore, fail to qualify for the government sponsored programs and loans as a result of their poor credit scores.

### SUMMARY OF THE INVENTION

In one aspect, the invention is a method of enabling a buyer to transition from renting a home to owning a home.

In another aspect, the invention is a system for advertising rental properties and encouraging home ownership.

In yet another aspect, the invention is a method of attracting potential renters and home buyers to service providers.

The foregoing, as well as other objectives and advantages of the invention and the manner in which the same are accomplished, is further discussed within the following detailed description.

### DETAILED DESCRIPTION

The invention relates to the field of real estate rentals and sales. More particularly, the present invention relates to the field of increased rates of home ownership. In one aspect, the invention is a method of enabling individuals to transition from rental property to home ownership.

As used herein, and as will be recognized by those having ordinary skill in the art, the term “individuals” encompasses individuals, families, roommates, and other groups of people, such as cohabiting couples, that may make use of the present method. The term “individuals” is being used for convenience and the disclosure and claims shall not be limited to single persons.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In one aspect, the invention is a method of enabling a buyer to transition from rental property to home ownership. The method includes establishing a database of available rental properties, utilizing the database to attract individuals to the available rental properties, and offering discounts on a subsequent home purchase to individuals that initially lease a rental property listed on the database and fulfill terms of a rental agreement.

In one embodiment the database is located on the World Wide Web (i.e., the Internet), enabling access to the database throughout the world at any time. The database may be structured to allow access to registered users only. In another embodiment, the database may be structured to allow access to all users, whether those users are registered users or guests. In yet another embodiment, the database may be structured to allow temporary access to guests and full access to registered users.

Additionally, the database may be structured to allow free access or paid subscription access to users.

In one embodiment, service providers may purchase a membership in a consortium of providers. Membership in the consortium would enable the service providers to advertise on the database. In one embodiment, property managers, including property managers of multiple rental properties (i.e., an apartment complex having multiple units, more than one apartment complex having multiple units, multiple single dwellings, and combinations thereof); property managers of single rental properties; and combinations thereof, may list their available rental properties on the database as members of the consortium. In another embodiment, property managers who are not members of the consortium may pay a fee to list their properties on the database.

Those having ordinary skill in the art will recognize that in order to manage residential properties for a third party, many states require property managers to be a licensed real estate agency. Official designations that property managers can obtain include, but are not limited to, Residential Property Management Professional (RMP®), Master Property Manager (MPM®), Certified Support Specialist (CSS®), and Certified Residential Management Company (CRMC®) combinations thereof, and the like. The specification should be read and understood to conform to the various state and/or federal laws regarding licensure of property managers.

As used herein, the term “property managers” is intended to include those people having responsibility for rental properties, whether they are hired managers of rental properties or owners of rental properties. Those having ordinary skill in the art will recognize that references to “property managers” throughout the specification shall not, therefore, be limited to hired managers of rental properties.

Other service providers that may join the consortium or pay a fee to advertise their services on the database may include, but not limited to, one or more of realtors, insurance agents, home appraisers, home/property inspectors, moving companies, repairmen, painters, mortgage brokers, banks, builders, property management software companies, credit counselors, appliance manufacturers, security companies, cable and/or satellite companies, internet providers, furniture sellers, and other service providers known in the art as providing services relating to a new home rental or home purchase.

Properties listed on the database may include rental properties that are also available for purchase at the conclusion of a rental period as well as rental properties that are available only for rent.

Additionally, properties listed on the database may include properties in more than one city and/or more than one state.

In an exemplary embodiment, an individual who rents a property listed on the database signs a rental agreement with the property manager that listed the property. The individual may also sign an addendum to the rental agreement, or an additional agreement, that specifies at least one offer that the individual is entitled to receive upon fulfillment of the terms on the rental agreement. In an exemplary embodiment, the individual may sign the addendum at the time of signing the rental agreement. In another embodiment, the individual may sign the addendum at a different time than signing the rental agreement.

Alternatively, the information regarding the at least one offer may be included in the rental agreement.

In one embodiment, the at least one offer may be a discount on a home purchase. For example, an individual that fulfills the terms of the rental agreement may be eligible, under the terms of the addendum or additional agreement, for a reduction in a realtor's commission rate and/or reduction in lender's fees and other closing costs.

As is known to those having ordinary skill in the art, realtors charge a commission, typically between about 4% and 10% of the total selling price of the house. That commission is often divided between a seller's agent and a buyer's agent.

In an exemplary embodiment of the present invention, a buyer's agent that is a member of the consortium or an advertiser on the database may offer an individual who has fulfilled the terms of the rental agreement a discount on the commission. For example, a 1% discount may be offered after the completion of a one-year lease (e.g., the realtor's commission would be reduced from 6% to 5%). A buyer's agent may offer an additional discount for completion of a longer lease. This discount would enable the transition from renter to home owner by lowering the amount of savings a renter may need before purchasing a home.

In another embodiment, where the buyer's realtor is also the listing agent of the property being purchased, the realtor may offer an additional discount on the commission total to an individual who has completed the terms of a rental agreement.

In yet another embodiment, a lender may offer a reduction in lender's fees to a buyer upon completion of the terms of the rental agreement.

The rental term would give a buyer with poor credit an opportunity to improve their credit scores through timely lease (or rent) payments while also providing the purchase price discount described above at the end of the rental term.

The rental term may also enable a buyer who has relocated to a new area the time necessary to research neighborhoods and the new city before committing to a home purchase. A relocating buyer would, therefore, enjoy the benefit of the time to learn a new community as well as a discount on the purchase price of a home.

In another embodiment, other service providers may offer discounts to individuals who fulfill the terms of a rental agreement as described above. For example, discounts may be offered on one or more of moving services, insurance, title fees, attorney's fees, appraisal services, mortgage fees, home inspection services, credit counseling, security services, cable or satellite services, internet provider services, furniture sales, appliance sales, and other services known in the art as being useful when moving, and combinations thereof.

The amount of the discount offered may be tailored to the length of the rental agreement signed by the individual (i.e., a 1% discount on a realtor's commission for a one-year rental and a 2% deduction for a two-year rental). Alternatively, the service provider may offer a single discount regardless of the length of the rental agreement. In another embodiment, the amount of the discount may be a flat cost tied to the amount of the service, i.e., $100.00 off of moving costs between $500 and $1,000 and $200.00 off moving costs above $1000.

Those having ordinary skill in the art will recognize that some state and federal laws limit the incentives that may be offered and/or require service providers to offer discounts in a non-discriminatory manner. Those having ordinary skill in the art will also recognize that some state and federal laws limit the discounts that may be offered on a home purchase. For example, some states do not allow direct discounts on brokerage or realtor fees. This specification should be read and understood to conform to the various state and federal laws.

In yet another embodiment, service providers that are members of the consortium and/or service providers that advertise on the database may offer discounts tailored to renters. For example, renters that sign a rental agreement with a participating property manager may be immediately eligible for a discount in renter's insurance, security services, cable or satellite services, internet providers, furniture purchases, and other services useful to renters.

Those having ordinary skill in the art will recognize that the various service providers identified in the application is representative only and is not intended to limit the service providers that may participate in the present method.

In another aspect, the invention is a system for advertising rental properties and encouraging home ownership. The system includes a database having a listing of available rental properties and information regarding discounts on future home purchases offered to renters who sign a rental agreement for one of the available rental properties and fulfill the terms of the rental agreement. The database may also include information regarding other services useful in purchasing a home.

In an exemplary embodiment, the database includes a listing of available rental properties owned or managed by members of a consortium including property managers. The consortium may also include other service providers, such as those listed above. The database may also include a listing of available rental properties managed by property managers who are not members of the consortium but pay a fee for the privilege of including their listings.

In another embodiment, the database may include rental properties in more than one city and/or state.

In one embodiment, the database includes information regarding discounts on realtor commissions that are available to individuals that fulfill the terms of a rental agreement on one of the rental properties listed in the database.

In another embodiment, the database may include information relating to additional discounts on a future home purchase that are available to individuals that fulfill the terms of a rental agreement and/or discounts that are available to renters who sign a rental agreement with participating property managers. These additional discounts may include one or more of discounts on homeowners insurance, moving services, appraisal services, home inspection services, attorney's fees, title services, credit counseling, renter's insurance, security services, lender's fees, closing costs, cable and/or satellite services, appliance sales, furniture sales, other services known in the art, and the like. In one embodiment, service providers may join the above described consortium to gain access to the database. In another embodiment, service providers may pay a fee to gain access to the database without joining the consortium.

In another embodiment, the database may also include additional information that is useful to individuals looking for information relating to renting or purchasing a home. For example, the database may include information relating to sample rental agreements, sample purchase agreements, property managers participating in the system, realtors participating in the system, homes for sale, other service providers (including without limitation those discussed above) participating in the system, other information known in the art as being useful when purchasing or renting a home, and the like.

In another aspect, the invention is a method of attracting potential home buyers. The method includes establishing a database (e.g., on the Internet) of available rental properties and offering discounts on a home purchase to individuals who initially rent property listed on the database and fulfill the terms of a rental agreement.

The method may further include establishing a database of available rental properties in more than one city and/or state. The method may also further include the step of updating the database to indicate when rental properties listed on the database become unavailable. In another embodiment, the method may also include the step of updating the database to indicate when additional rental properties become available.

The method and system of the present invention provide benefits to service providers and individuals renting or purchasing a home. Service providers participating in the consortium or purchasing advertising space on the database have access to renters and home buyers. The discounts offered upon fulfillment of the rental agreement encourage potential renters and home purchasers to use the present database rather than previously existing services.

Additionally, the discounts may attract a greater number of individuals to the database looking for rental properties. As a result, property managers may have higher occupancy rates as a result of their participation in the consortium. Additionally, discounts offered to renters, such as discounts on renter's insurance, will likely encourage renters to use the present database to find rental homes.

Moreover, those renters that fulfill their rental agreements with the property managers participating in the present method and system receive reduced rates on many of the services and costs of purchasing a new home. This enables improved rates of home ownership by lowering the upfront costs of purchasing a home and providing an opportunity for home purchasers to improve their credit scores in advance of purchasing a home, thereby qualifying for lower mortgage interest rates.

Service providers may be motivated to participate in the consortium because the database may help lower advertising costs. The discounts offered by the service providers may be offered exclusively to individuals that rent a property with participating property managers and/or fulfill the terms of a rental agreement on a property listed on the database. These individuals are each potential customers for the service providers. Accordingly, the service providers do not have to expend additional advertising dollars to reach these consumers. The reduced advertising costs may serve to offset the discounts offered through the database.

In the specification there have been disclosed typical embodiments of the invention and, although specific terms have been employed, they have been used in a generic and descriptive sense only and not for purposes of limitation, the scope of the invention being set forth in the following claims.

1. A method of facilitating an individual to transition from rental property to home ownership, the method comprising:
establishing a database of available rental properties;
utilizing the database to attract individuals to the available rental properties; and
offering discounts on a home purchase to individuals that initially rent a rental property advertised on the database and fulfill terms of a rental agreement.

2. The method of claim 1 wherein said database is Internet based.

3. The method of claim 1 wherein the step of establishing a database of available rentals comprises establishing a database of available rental property in more than one city.

4. The method of claim 1 wherein the step of establishing a database of available rentals comprises establishing a database of available rental property in more than one state.

5. The method of claim 1 wherein the step of attracting individuals comprises attracting families.

6. The method of claim 1 wherein the step of attracting individuals comprises attracting roommates.

7. The method of claim 1 wherein the step of offering discounts comprises offering a discount on a realtor's commission.

8. The method of claim 7 wherein the step of offering a discount on a realtor's commission comprises offering a 1% discount on the realtor's standard commission.

9. The method of claim 8 wherein the step of offering a 1% discount on the realtor's standard commission further comprises offering an additional discount if the realtor is also the listing agent of the purchased home.

10. The method of claim 1 wherein the step of offering discounts comprises offering discounts on closing costs.

11. The method of claim 1 wherein the terms of a rental agreement comprise a one year lease.

12. The method of claim 1 further comprising offering additional discounts to renters who sign a lease for more than one year.

13. The method of claim 1 wherein the step of offering a discount comprises offering a discount on homeowner's insurance.

14. The method of claim 1 wherein the step of offering a discount comprises offering a discount on moving services.

15. A system for advertising rental properties and encouraging home ownership, the system comprising:
an interface for users accessing a database;
said database including:
a listing of available rental properties;
information regarding discounts on future home purchases offered to renters who sign a rental agreement for one of the available rental properties and fulfill the terms of the rental agreement; and
information regarding other services useful in purchasing or renting a home.

16. A system according to claim 15 wherein said listing of available rental properties comprises rental properties owned by members of a consortium of property managers.

17. A system according to claim 15 wherein said listing of available rental properties comprises rental properties in more than one city.

18. A system according to claim 15 wherein said listing of available rental properties comprises rental properties in more than one state.

19. A system according to claim 15 wherein said information regarding discounts on future home purchases comprises information relating to discounted realtor commissions.

20. A system according to claim 15 wherein said information regarding discounts on future home purchases comprises information relating to discounted homeowners insurance.

21. A system according to claim 15 wherein said information regarding discounts on future home purchases comprises information relating to discounted closing costs.

22. A system according to claim 15 wherein said information regarding discounts on future home purchases comprises information relating to discounted moving services.

23. A system according to claim 15 further comprising information regarding discounts on services available before completion of the terms of the rental agreement.

24. A system according to claim 15 further comprising sample rental agreements.

25. A system according to claim 15 wherein said database further comprises information relating to homes for sale.

26. A system according to claim 15 wherein said database further comprises information relating to property managers participating in a discount program.

27. A system according to claim 15 wherein said database further comprises information relating to real estate brokers participating in a discount program.

28. A system according to claim 15 wherein said information regarding other services useful in purchasing or renting a home comprises one or more of information relating to credit bureaus, mortgage brokers, appraisers, home inspectors, insurance programs, real estate attorneys, and title companies, appliance manufacturers, real estate agents, builders, security companies, cable companies, satellite companies, and furniture companies.

29. A method of attracting potential renters and home buyers, the method comprising:
establishing a database of available rental properties; and
offering discounts on a home purchase to individuals that initially rent a rental property listed on the database and fulfill terms of a rental agreement.

30. A method according to claim 29 wherein the step of establishing a database comprises establishing a database on the internet.

31. A method according to claim 29 wherein the step of establishing a database of available rental properties comprises establishing a database of available rental properties in more than one city.

32. A method according to claim 29 wherein the step of establishing a database of available rental properties comprises establishing a database of available rental properties in more than one state.

33. A method according to claim 29 further comprising the step of updating the database to indicate when rental properties listed on the database become unavailable.

34. A method according to claim 29 further comprising the step of updating the database to indicate when additional rental properties become available.

35. A method according to claim 29 wherein the step of offering discounts on a home purchase to individuals that initially rent a rental property listed on the database and fulfill terms of a rental agreement comprises offering discounts on one or more of realtor commissions, insurance, closing costs, mortgage interest rates, moving services, appraisal services, home inspection services, home repair services, and home warranties, lender's fees, security systems, furniture purchases, appliance purchases, cable services, internet provider services, and satellite services.

36. A method according to claim 29 further comprising the step of offering discounts to renters who sign a rental agreement.

37. A method according to claim 36 wherein the step of offering discounts comprises offering discounts on one or more of renter's insurance, moving services, security systems, furniture purchases, appliance purchases, cable services, internet provider services, and satellite services.
